(19) United States
(12) Patent Application Publication
(10) Pub. No.: US 2012/0002985 A1
(43) Pub. Date: Jan. 5, 2012

(54) Image Forming Apparatus and Method

(75) Inventor: Junichi KATAYAMA, Shizuoka (JP)

(73) Assignees: Toshiba Tec Kabushiki Kaisha, Tokyo (JP); Kabushiki Kaisha Toshiba, Tokyo (JP)

(21) Appl. No.: 13/153,358

(22) Filed: Jun. 3, 2011

Related U.S. Application Data
(60) Provisional application No. 61/360,468, filed on Jun. 30, 2010.

(51) Int. Cl. G03G 15/00; G03G 15/08

(52) U.S. Cl. 399/21; 399/53; 399/27

(57) ABSTRACT

Certain embodiments provide an image forming apparatus including: a drum; a photoconductive member; a charging device; a developing device; a toner supplying section; a transfer member; a sensor to measure the density of a toner band adhering on the transfer member; a process control section to separately control on and off of a developing bias and on and off of a charging bias; a timing adjusting section to instruct the process control section to turn on the developing bias at timing when a portion not substantially charged on the photoconductive member is opposed to the developing device; and a calculating section to calculate an amount of supply of toner from the toner supplying section into the developing device according to a result of measurement of the density of the toner band which is formed by the developing bias enabled by the timing adjusting section by the sensor.

### CROSS-REFERENCE TO RELATED APPLICATION

The present application claims priority under 35 U.S.C. 119 to U.S. Provisional Application Ser. No. 61/360,468, to Katayama, filed on Jun. 30, 2010, the entire disclosure of which is incorporated herein by reference.

### FIELD

Embodiments described herein relate generally to an image forming apparatus and a method of calculating an amount of supply of toner.

### BACKGROUND

An image forming apparatus by an electrophotographic system consumes a toner. There is known an image forming apparatus that controls an amount of supply of toner using an ATC (automatic toner control) sensor. The ATC sensor is provided in a developing device and detects an amount of toner.

There is also known an image forming apparatus that controls supply of a toner without using the ATC sensor. In an ATC-less method, for example, at the end of printing or during warming-up, the image forming apparatus prints a test pattern on a transfer belt. The image forming apparatus prints the test pattern according to a reversal development process.

The image forming apparatus estimates a necessary amount of supply of toner from an amount of toner adhering on the transfer belt. There is known a method of controlling supply of a toner without using a toner sensor in a developing device.

The image forming apparatus, however, needs time for forming the test pattern on a transfer member. The image forming apparatus needs to secure the time except while a printing process is being executed.

After forming the test pattern according to the reversal development process, the image forming apparatus optically measures the density of the test pattern. The image forming apparatus needs time for executing the formation of the test pattern and the measurement of the density.

The image forming apparatus does not receive a user request until the image forming apparatus ends the formation of the test pattern and the measurement of the density. The user cannot perform printing. When the image forming apparatus acquires an amount of the supply of toner without the toner sensor in the developing device, the user is kept waiting.

### BRIEF DESCRIPTION OF THE DRAWINGS

FIG. 1 is a diagram of an image forming apparatus according to a first embodiment;

FIG. 2 is a diagram of a configuration example of one image forming process unit used in the image forming apparatus;

FIG. 3 is a lower perspective view of a sensor used in the image forming apparatus;

FIG. 4 is a block diagram of a control system shown with attention paid to a function of executing a method of calculating an amount of supply of toner according to the first embodiment;

FIG. 5 is a diagram of an example of a correspondence relation stored in a table used in the image forming apparatus;

FIG. 6 is a flowchart for explaining the method of calculating an amount of the supply of toner;

FIG. 7A is a diagram for explaining a relation of potentials in the case in which an absolute value of charging bias potential is larger than an absolute value of developing bias potential;

FIG. 7B is a diagram for explaining a relation of potentials in the case in which the absolute value of the charging bias potential is smaller than the absolute value of the developing bias potential;

FIG. 8 is a diagram for explaining a relation between the positions of transferred four toner bands and the position of a sensor;

FIGS. 9A to 9E are timing charts for explaining processing for ending a series of printing processes by the image forming apparatus;

FIGS. 10A to 10E are diagrams of charging states on a photoconductive member used in the image forming apparatus;

FIGS. 11A to 11E are timing charts for explaining processing for starting a series of printing processes by an image forming apparatus according to a second embodiment; and

FIGS. 12A to 12D are diagrams of charging states on a photoconductive member used in the image forming apparatus.

### DETAILED DESCRIPTION

Certain embodiments provide an image forming apparatus including: a drum driven to rotate around an axis in a drum rotating direction; a photoconductive member on the outer circumferential surface of the drum; a charging device configured to charge the photoconductive member; a developing device configured to supply a toner to the photoconductive member further downstream in the drum rotating direction than the charging device; a toner supplying section configured to supply the toner to the developing device; a transfer member onto which a toner image on the photoconductive member is transferred further downstream in the drum rotating direction than the developing device; a sensor configured to measure the density of a toner band adhering on the transfer member; a process control section configured to control the operation of the sensor, separately control on and off of a developing bias to the developing device and on and off of a charging bias to the charging device, and control execution of a printing process on a sheet; a timing adjusting section configured to instruct the process control section to turn on the developing bias at timing when a portion not substantially charged on the photoconductive member of the drum rotated by the control by the process control section is opposed to the developing device; and a calculating section configured to calculate, according to a result obtained by the sensor measuring the density of the toner band formed by the developing bias enabled by the timing adjusting section, an amount of supply of toner from the toner supplying section into the developing device.

An image forming apparatus and a method of calculating an amount of supply of toner are explained in detail with reference to the accompanying drawings as examples. In the figures, the same components are denoted by the same reference numerals and signs and redundant explanation of the components is omitted.

### First Embodiment

An image forming apparatus according to a first embodiment is an MFP (multi function peripheral). A method of calculating an amount of supply of toner according to the first embodiment is a method of forming a toner band on a transfer belt, detecting the density of the toner band, and calculating the amount of the supply of toner according to the density.

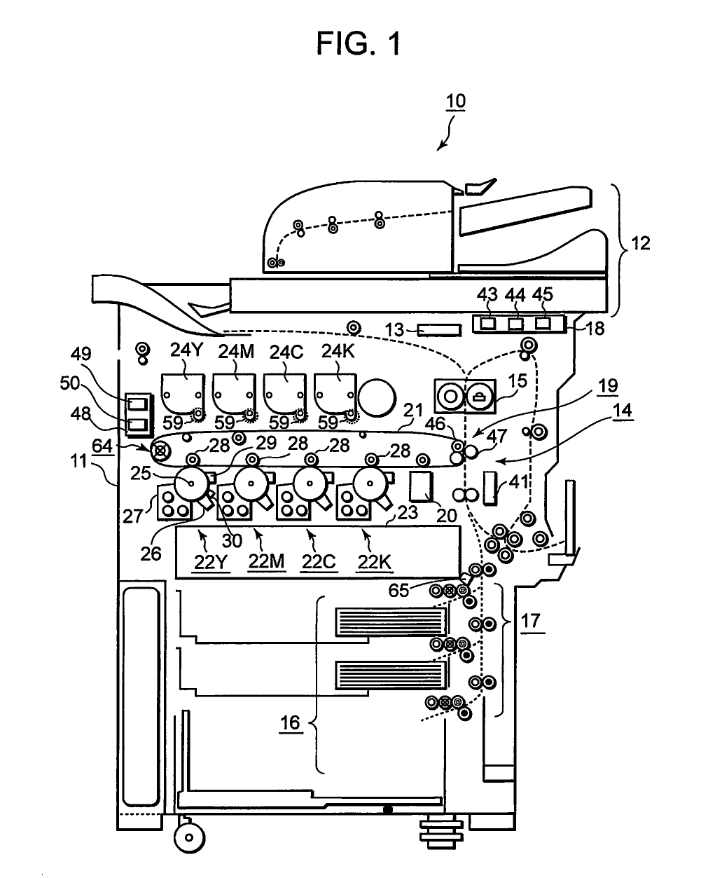

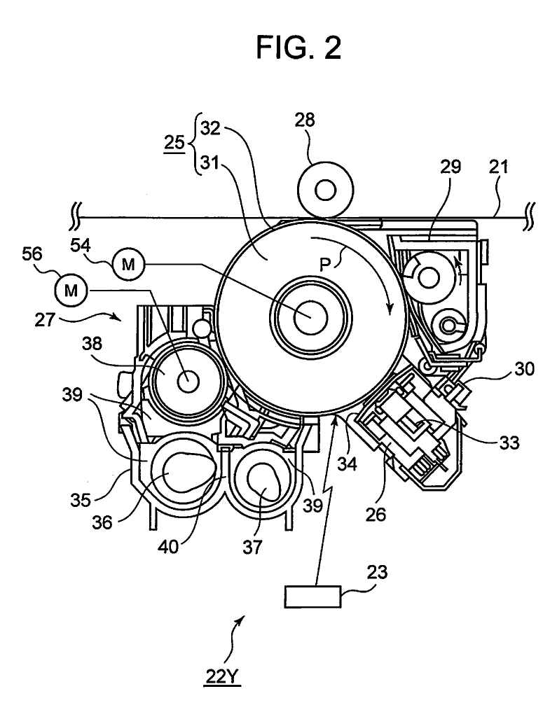

FIG. 1 is a diagram of the MFP. FIG. 2 is a diagram of a configuration example of one image forming process unit. The same reference numerals and signs denote the same components.

A MFP 10 includes a main body 11, a scanner section 12, an image processing section 13, a printing section 14, a fixing device 15, a paper feeding section 16, a conveying mechanism 17, a controller 18, a secondary transfer section 19, and a toner deposit sensor (a sensor) 20.

The scanner section 12 scans a document surface and outputs image data. The image processing section 13 corrects the image data.

The printing section 14 forms an image on a sheet and outputs the sheet. The fixing device 15 fixes an unfixed image on the sheet.

The printing section 14 includes a belt (a transfer member) 21, an image forming process unit for yellow (Y) 22Y, an image forming process unit for magenta (M) 22M, an image forming process unit for cyan (C) 22C, and an image forming process unit for black (K) 22K, and a laser exposure device 23.

The MFP 10 includes toner cartridges (toner supply sections) 24Y, 24M, 24C, and 24K configured to store supply toners of the respective colors.

The toner cartridges 24Y, 24M, 24C, and 24K supply the toners to developing devices 27 corresponding thereto.

The toner cartridges 24Y, 24M, 24C, and 24K are respectively coupled to couplers 59 on the main body 11 side.

The belt 21 is an intermediate transfer belt. A driving roller 64 drives the belt 21.

The image forming process unit 22Y includes, as shown in FIG. 2, a photoconductive drum 25, a charging device 26, the developing device 27, a primary transfer roller 28, a cleaner 29, and a charge removing device 30.

The photoconductive drum 25 includes a drum 31 driven to rotate around an axis in a drum rotating direction (an arrow P direction) and a photoconductive member 32 on the outer circumferential surface of the drum 31.

The charging device 26 causes a wire 33 to generate corona discharge and charge the photoconductive member 32. The charging device 26 changes a charging amount on the photoconductive member 32 according to a grid bias voltage from a grid electrode 34 and stabilizes the corona discharge.

The developing device 27 develops an electrostatic latent image or a toner band on the photoconductive member 32 at developing bias potential. The toner band has band length in parallel to a rotation axis of the drum 31 and band width in the circumferential length direction on the photoconductive member 32.

The developing device 27 includes a container 35 filled with a two-component developer. The developer includes a toner and a carrier that exhibits magnetism.

In the developing device 27, mixers 36 and 27 and a magnet roller 38 are included in the container 35. The container 35 includes plural chambers 39 and a wall 40. The upper chamber 39 has an opening that faces the photoconductive drum 25. An opening having an image region size along a drum axis is a development position.

The wall 40 causes the chambers 39 to partially communicate with each other. The chamber 39 is coupled to the toner cartridge 24Y directly or via a toner carrying path. The toner cartridge 24Y supplies the toner to the container 35.

The mixers 36 and 37 agitate and circulate the developer.

The magnet roller 38 is a sleeve. The magnet roller 38 carries the toner on the sleeve outer circumferential surface.

The developing device 27 brings a magnetic brush into contact with the outer circumferential surface of the photoconductive drum 25. The magnet roller 38 and the photoconductive drum 25 rotate. The developing device 27 supplies the toner to an electrostatic latent image using the magnetic brush.

The primary transfer roller 28 transfers a toner image on the photoconductive drum 25 onto the belt 21 downstream in the drum rotating direction. The cleaner 29 removes the toner remaining on the photoconductive drum 25 after the primary transfer. The cleaner 29 collects the toner in a box 41.

The charge removing device 30 removes charges on the photoconductive drum 25. The charge removing device 30 is, for example, an LED (light emitting diode).

The configuration of the image forming process units 22M, 22C, and 22K is substantially the same as the configuration of the image forming process unit 22Y.

In the paper feeding section 16, sheets are respectively set in cassettes. The conveying mechanism 17 feeds the sheets from the paper feeding section 16 to the printing section 14.

The controller 18 includes a CPU (central processing unit) 43, a ROM (read only memory) 44, and a RAM (random access memory) 45.

The controller 18 functions as a process control section 66. The controller 18 controls on and off of a developing bias to the magnet roller 38. The controller 18 controls on and off of a charging bias to the charging device 26. The controller 18 separately controls the magnet roller 38 and the charging device 26.

The controller 18 causes the printing section 14 to execute a printing process. The controller 18 controls the operation of the toner deposit sensor 20.

The controller 18 functions as a timing adjusting section 67. The controller 18 instructs application of a developing bias to the magnet roller 38 at timing when an uncharged portion on a photoconductive surface of the photoconductive drum 25 is opposed to the magnet roller 38.

The controller 18 adjusts application timing of a transfer bias voltage as well. The CPU 43 executes a function of a timing adjusting section according to a timer and a program code.

The controller 18 functions as a calculating section 68. The controller 18 causes the toner deposit sensor 20 to measure the density of a toner band formed by the controller 18 enabling the developing bias. The controller 18 calculates the amount of the supply of toner from the toner cartridge 24Y into the container 35 for yellow according to a measurement result.

The density indicates a value obtained by dividing the total weight of a toner present on a band-like region by an area of the region. The density is represented by, for example, mg/cm².

The CPU 43 loads a computer program stored in the ROM 44 to the RAM 45 and executes the computer program, whereby functions of the process control section 66, the timing adjusting section 67, and the calculating section 68 are executed.

Examples of the toner cartridges 24M, 24C, and 24K for magenta, cyan, and black are the same as the example of the toner cartridge 24Y.

The controller 18 determines the amount of the supply of toner according to a correspondence relation stored in a table 57. The amount of the supply of toner indicates an amount of toner that should be added in the container of the developing device 27. The controller 18 determines, for each of the colors, amounts of supply of toners added to the developing devices 27.

The secondary transfer section 19 transfers a toner image on the belt 21 onto a sheet. The secondary transfer section 19 includes a backup roller 46 and a secondary transfer roller 47.

The secondary transfer section 19 secondarily transfers a color toner image onto a sheet according to application of a transfer bias to the backup roller 46.

The toner deposit sensor 20 is a photosensor configured to optically detect an amount of toner adhering on the belt 21.

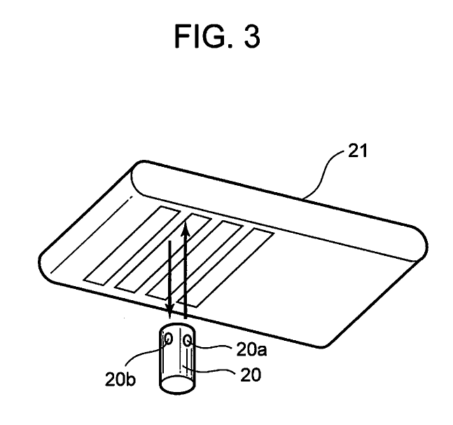

FIG. 3 is a lower perspective view of the toner deposit sensor 20. The reference numerals and signs already described above denote the same components.

The toner deposit sensor 20 includes a light emitting element 20a that emits a light beam and a light receiving element 20b that optically reads a reflected light beam reflected on toner band images of the respective colors transferred onto the surface of the belt 21. The light emitting element 20a is an LED (light emitting diode). The light receiving element 20b is a photodiode.

The toner deposit sensor 20 receives reflected light of an amount corresponding to the density of a toner band, converts a detected current into a voltage, and outputs the voltage. The toner deposit sensor 20 converts the output voltage into a digital value using an analog-to-digital converter and returns the digital value to the controller 18. The digital value represents a sensor output having a level corresponding to the density of an image of the toner band.

The controller 18 allocates regions of toner bands of the four colors onto the belt surface of the belt 21. The controller 18 allocates the toner bands of the respective colors such that the toner bands do not overlap one another in a traveling direction of the belt 21.

The MFP 10 includes a power supply section 48. The power supply section 48 includes a high-voltage power supply section 49 and a low-voltage power supply section 50.

The high-voltage power supply section 49 supplies high voltages of different levels respectively to the charging device 26, the developing device 27, and the primary transfer roller 28. The high voltages indicate voltages of several hundred volts to several kilovolts.

The high-voltage power supply section 49 supplies a charging bias voltage to the wire 33. The high-voltage power supply section 49 supplies a grid bias voltage to the grid electrode 34. The high-voltage power supply section 49 supplies a developing bias voltage to the magnet roller 38.

The low-voltage power supply section 50 supplies low voltages to an electronic circuit, a motor, and a sensor. The low-voltages indicate a voltage for the electronic circuit and a driving voltage for the motor.

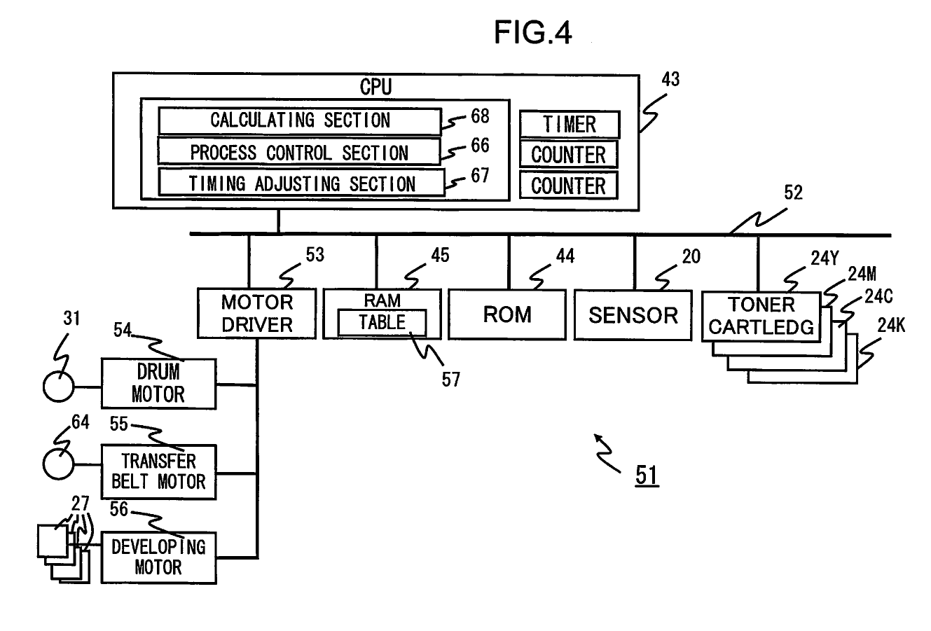

FIG. 4 is a block diagram of a control system shown with attention paid to a function of executing the method of calculating the amount of the supply of toner. The reference numerals and signs already described above denote the same components.

A control system 51 includes a bus 52, a motor driver 53, a drum motor 54, a transfer belt motor 55, and a developing motor 56.

The CPU 43 includes a timer, counters, and hardware for an arithmetic operation. The ROM 44 has stored therein a computer program in which an arithmetic operation procedure for calculation is described. A setting value of a development continuation time for determining band length of a toner band is stored in the ROM 44.

The RAM 45 includes the table 57 that stores a correspondence relation between information indicating an amount of toner output by the toner deposit sensor 20 and information indicating an amount of toner that should be supplied.

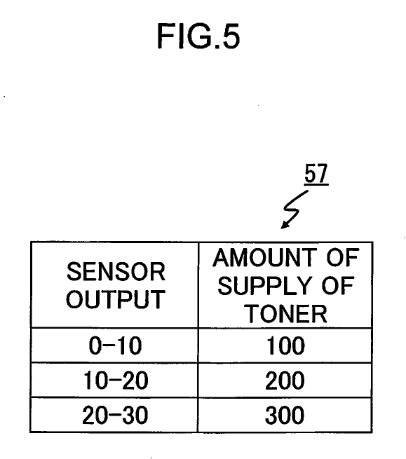

FIG. 5 is a diagram of an example of the correspondence relation stored in the table 57. If a value of a sensor output indicating toner density is larger, the amount of the supply of toner is larger. Values of the table 57 are determined through an experiment, a simulation, a test, or the like. An SRAM (static random access memory) is used as the RAM 45.

The motor driver 53 shown in FIG. 4 controls rotating speed of the drum motor 54. The drum motor 54 rotates the drums 31 of the four photoconductive drums 25. The transfer belt motor 55 rotates the driving roller 64.

The developing motor 56 rotates one or both of the mixers 36 and 37 and the magnet rollers 38 of the developing devices 27.

The CPU 43 calculates amounts of supply of toners from the toner cartridges 24Y, 24M, 24C, and 24K to the developing devices 27 corresponding thereto according to a sensor output of the toner deposit sensor 20 and the correspondence relation stored in the table 57.

The MFP 10 having the configuration explained above completes formation of a toner band by an analog development process (a regular development process) and detection of an amount of supply toner while printing by a normal reversal development process is executed.

The reversal development process indicates a process for depositing a toner on a latent image, from which charges on the photoconductive member are removed by exposure, and developing the latent image with a toner.

The analog development process indicates a process for causing an unexposed portion on the photoconductive member to attract the toner. The analog development process is a process for forcibly applying a developing bias when a charging bias is not applied and causing fog.

First, when an original document is input to the MFP 10 on standby, the MFP 10 starts execution of the normal reversal development process.

In the reversal development process, the scanner section 12 reads a document surface. The image processing section 13 corrects image data. The drum motor 54 starts to rotate the photoconductive drum 25. The charging device 26 uniformly charges the photoconductive member 32.

The printing section 14 modulates laser beams of the respective colors according to image signals of the four colors. The laser exposure device 23 generates digital light and shade on the photoconductive drum 25 according to the reversal development process.

The potential of an exposed bright portion falls. The photoconductive drum 25 holds an electrostatic latent image on the photoconductive member 32.

A minus toner does not adhere to a region having relatively high potential on the photoconductive drum 25. The toner adheres to a region having relatively low potential.

The secondary transfer section 19 applies a bias having plus polarity to a sheet. The secondary transfer section 19 transfers a color toner image on the photoconductive drum 25 onto the sheet. Thereafter, the fixing device 15 fixes toners on the sheet.

The reversal development process is as explained above. The MFP 10 starts processing for ending the printing process.

Processing in which the MFP 10 calculates the amount of the supply of toner using the analog development process is explained below.

A method of calculating the amount of the supply of toner according to this embodiment is as indicated by (a) to (c) below.
(a) The controller 18 adjusts timing of on and off of a charging bias and timing of on and off of a developing bias during processing for ending the printing process by the image forming process units 22Y, 22M, 22C, and 22K. The controller 18 intentionally forms toner bands on the photoconductive drum 25 and the belt 21.
(b) The controller 18 reads the toner band on the belt 21 using the toner deposit sensor 20. The controller 18 detects the density of the toner band and refers to the table 57.
(c) The controller 18 determines the amount of the supply of toner according to a detection value of the density.

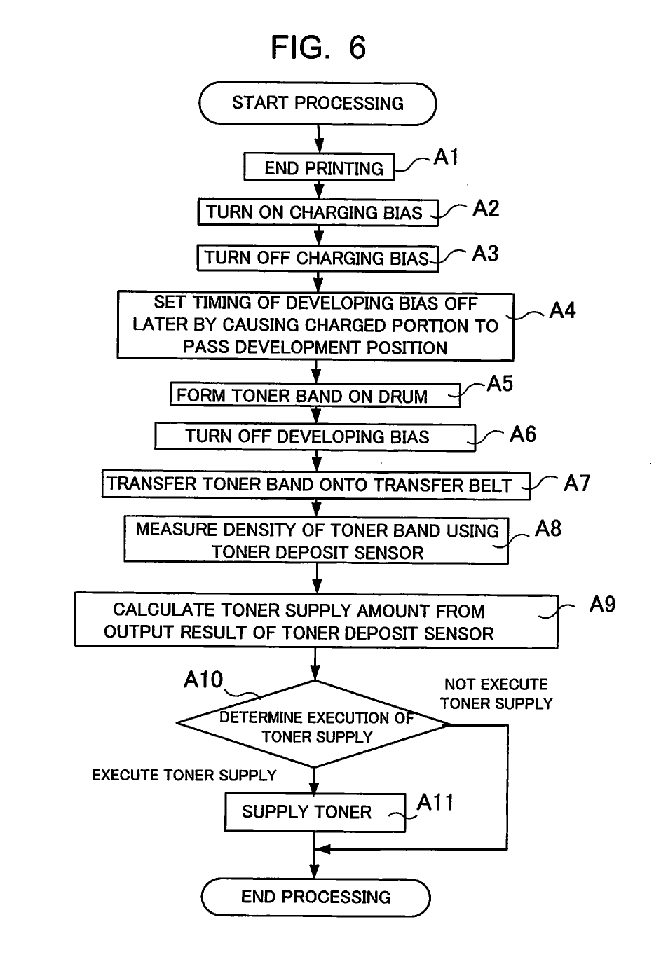

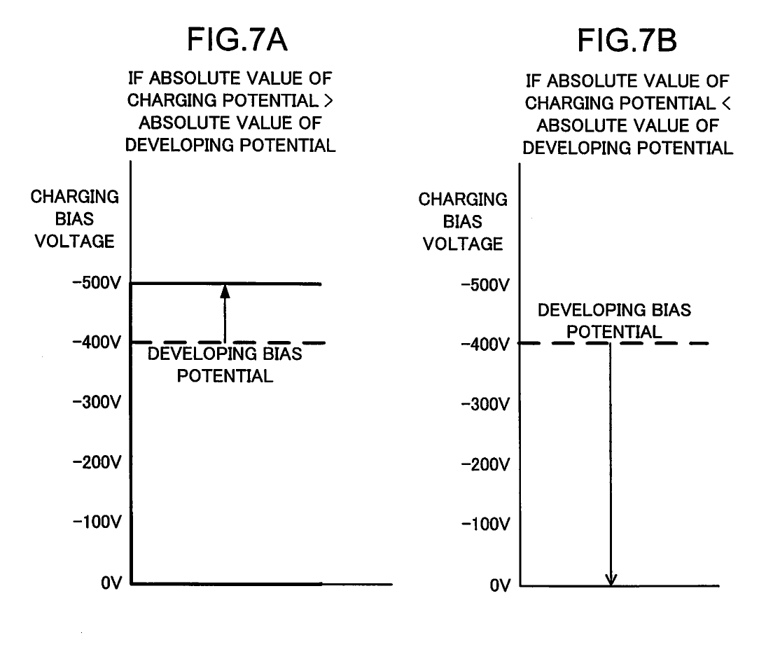

A method of executing the analog development process and calculating the amount of the supply of toner at the end of the normal printing process is explained below with reference to FIG. 6. Driving timings for charging, development, and transfer are explained with reference to FIGS. 7A to 10.

FIG. 6 is a flowchart for explaining the method of calculating the amount of the supply of toner. In Act A1, the controller 18 executes printing on one sheet.

An example of printing with the yellow toner is explained below. Before the controller 18 is about to end the printing process, the controller 18 causes the cleaner 29 to clean the photoconductive member 32 of the image forming process unit for yellow 22Y.

The controller 18 continues to rotate the photoconductive drum 25. The charge removing device 30 removes charges on the photoconductive member 32.

In Act A2, the controller 18 applies a charging bias. The photoconductive member 32 starts to have charges thereon.

In Act A3, the controller 18 turns off the charging bias. A band-like charged region is formed in the circumferential direction of the photoconductive member 32.

In Act A4, the controller 18 rotates the photoconductive drum 25 at a certain angle. The charged region passes the development position according to the rotation of the photoconductive drum 25 for yellow.

The controller 18 delays timing for turning off a developing bias by causing the charged region to pass the development position. The controller 18 keeps the developing bias on after an uncharged region starts to face the developing device 27 until the drum 31 finishes rotating at a certain angle.

In Act A5, a yellow toner band starts to be formed on the photoconductive member 32 by an analog development process caused as a result of causing the charged region to pass the development position. In Act A5, the controller 18 does not immediately turn off the developing bias when a region upstream in the drum rotating direction of the charged region starts to face the developing device 27.

The controller 18 does not turn off the developing bias after the uncharged region further downstream in the drum rotating direction than the charged region starts to face the developing device 27 until a toner band having band width of about 1 cm is formed.

The band width of about 1 cm is a value determined in advance in order to cause a toner of an amount sufficient for the toner deposit sensor 20 to detect density to adhere on the belt 21.

In Act A6, the controller 18 turns off the developing bias at timing when the toner band having the band width of about 1 cm is formed on the photoconductive drum 25 for yellow.

FIG. 7A is a diagram of a relation of potentials in the case in which an absolute value of charging bias potential is larger than an absolute value of developing bias potential. FIG. 7B is a diagram of a relation of potentials in the case in which the absolute value of the charging bias potential is smaller than the absolute value of the developing bias potential. An example of the developing bias potential is indicated by a broken line level.

Before the uncharged region reaches the portion opposed to the developing device 27, a relation of a potential difference is as indicated by an example shown in FIG. 7A. After the uncharged region reaches the portion opposed to the developing device 27 through the processing in Act A4, a relation of a potential difference is as indicated by an example shown in FIG. 7B.

In Act A7, the controller 18 transfers a resultant yellow toner band formed onto the belt 21.

Subsequently, in Act A8, the controller 18 measures the density of the yellow toner band using the toner deposit sensor 20.

In Act A9, the controller 18 refers to the table 57 according to density information output from the toner deposit sensor 20. The controller 18 calculates a value of the amount of the supply of toner.

In Act A10, the controller 18 determines, according to the magnitude of the value of the amount of the supply of toner, whether the toner is supplied.

If the value is small, the controller 18 ends the processing through a route described as “not execute toner supply”.

If the value is large in Act A10, in Act A11, the controller 18 supplies the toner through a route described as “execute toner supply”.

The controller 18 drives to rotate any one of the four couplers 59. The coupler 59 drives to rotate a mixer of the toner cartridge 24Y in one direction. The toner cartridge 24Y supplies the yellow toner from a discharge port of the toner cartridge 24Y to the developing device 27 for yellow.

Methods of calculating amounts of supply of toners of magenta, cyan, and black are substantially the same as the method of calculating the amount of the supply of toner of yellow.

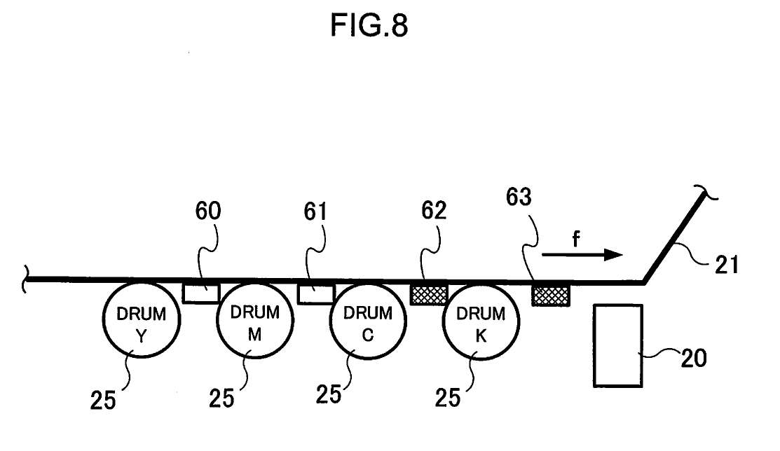

FIG. 8 is a diagram of a relation between the positions of transferred four toner bands and the position of the toner deposit sensor 20. The reference numerals and signs already described above denote the same components.

The controller 18 forms a yellow toner band 60, a magenta toner band 61, a cyan toner band 62, and a black toner band 63 on the photoconductive drums 25.

During the processing in Act A7, the controller 18 transfers the four toner bands 60, 61, 62, and 63 onto the belt 21 such that the toner bands 60, 61, 62, and 63 do not overlap one another in the belt traveling direction (an arrow f direction).

The toner deposit sensor 20 detects the densities of the toner bands. The controller 18 calculates amounts of supply of toners to the developing devices 27.

The MFP 10 uses the toner bands 60, 61, 62, and 63 by analog development as test patterns generated during reversal development.

Consequently, the MFP 10 can form the toner bands 60, 61, 62, and 63 during the normal printing processing. The MFP 10 can calculate amounts of supply of toners without securing a density measurement time separately from a printing process for one sheet.

Timings of the respective kinds of processing shown in FIG. 6 are explained below.

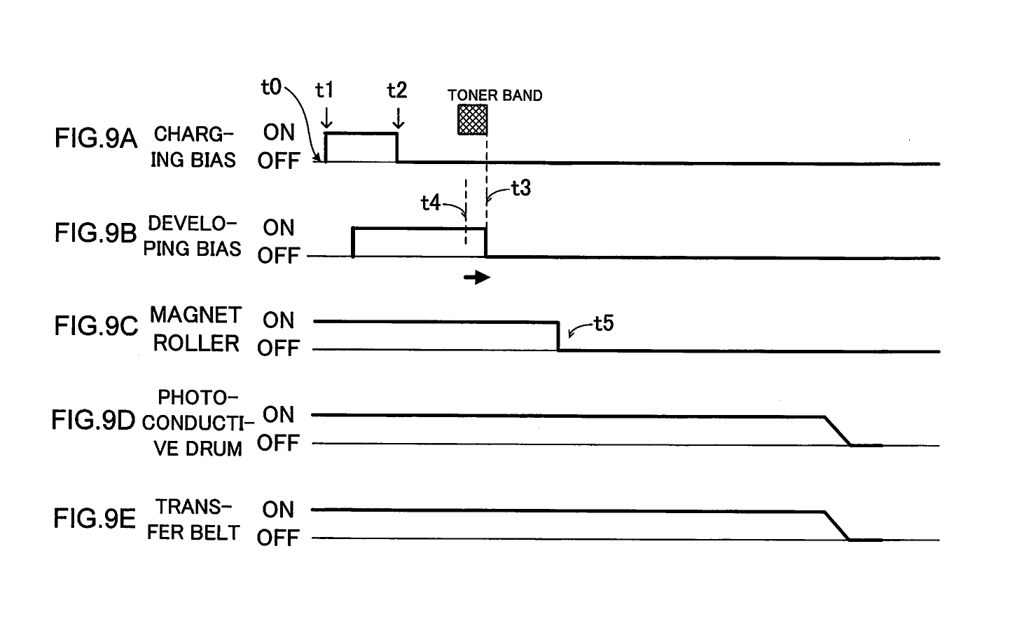

FIGS. 9A to 9E are timing charts for explaining processing for ending a series of printing processes by the image forming apparatus according to the first embodiment.

Low indicates that bias application is on and motor rotation is on. High indicates that the bias application is off and the motor rotation is off.

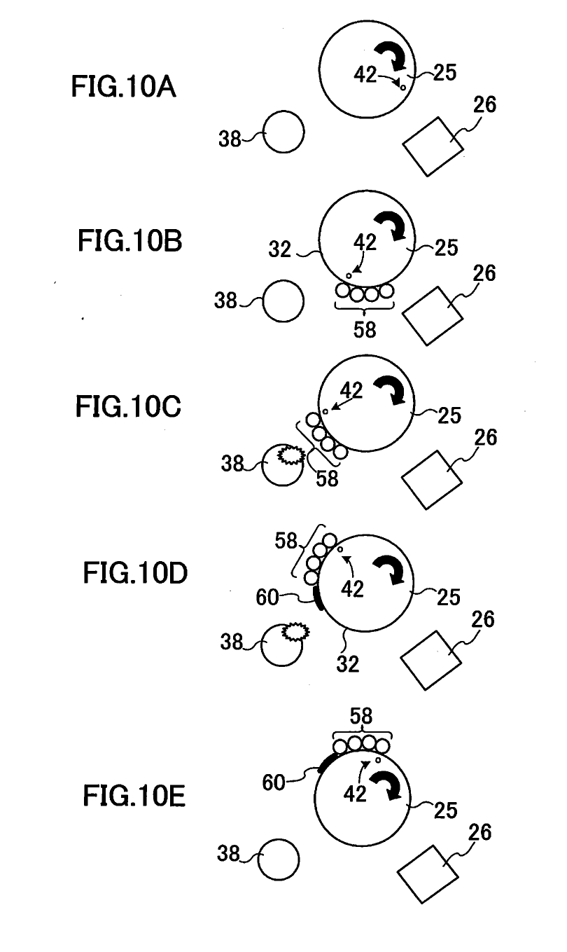

FIGS. 10A to 10E are diagrams of charging states on the photoconductive drum 25 used in the image forming apparatus according to the first embodiment. The reference numerals and signs already described above denote the same components. Four circles represent charges. A mark 42 represents a position in the circumferential length direction of a drum flange.

At time t0 shown in FIG. 9A, the controller 18 executes the charge removal in Act A1. As shown in FIG. 10A, the photoconductive drum 25 is not charged at all in the drum circumferential length direction.

According to the rotation of the photoconductive drum 25, the mark 42 is opposed to the magnet roller 38 in an opposed position (a first opposed position). At time t1, the controller 18 turns on a charging bias.

While the photoconductive drum 25 rotates a distance that is short compared with the length of one rotation in the drum circumferential length direction, the charging device 26 continues to apply the charging bias.

After the mark 42 passes an opposed position (a second opposed position) opposed to the charging device 26, as shown in FIG. 9A, at time t2, the controller 18 turns off the charging bias. As shown in FIG. 10B, the photoconductive member 32 is charged only in a portion 58 charged in the drum circumferential length direction.

As shown in FIG. 10C, the charged portion 58 is opposed to the magnet roller 38. The controller 18 turns on a developing bias.

The photoconductive drum 25 further rotates. As shown in FIG. 10D, a portion not having charges is opposed to the magnet roller 38. The toner band 60 starts to be formed. A minus toner is attracted to the photoconductive member 32.

The photoconductive drum 25 further rotates. At timing when the band width increases to about 1 cm, the controller 18 turns off the developing bias. This timing is equivalent to time t3 shown in FIG. 9B. As shown in FIG. 10E, the photoconductive drum 25 rotates.

Thereafter, the controller 18 executes detection of density and calculation of the amount of the supply of toner.

At time t5 shown in FIG. 9C, the controller 18 stops the rotation of the magnet roller 38.

As shown in FIG. 9D, the controller 18 stops the rotation of the photoconductive drum 25. As shown in FIG. 9E, the controller 18 stops the traveling of the belt 21.

In other words, the controller 18 completes the analog development process before the printing process ends.

Time t4 shown in FIG. 9B represents timing for turning off a developing bias by an image forming apparatus according to a comparative example. The image forming apparatus according to the comparative example turns off the developing bias when a charged region is opposed to a developing device.

The image forming apparatus according to the comparative example turns off the developing bias before an uncharged portion is opposed to the developing device. The image forming apparatus according to the comparative example does not cause a relation shown in FIG. 10D.

On the other hand, the controller 18 of the MFP 10 sets timing for turning off the developing bias later than time t4 when the developing bias is turned off in the comparative example. The controller 18 sets, for the four colors, timing for turning off the developing bias later than that in the comparative example to generate the toner bands 60, 61, 62, and 63.

In summary, at the end of printing, the MFP 10 executes in order the processing for turning off the charging bias, the processing for turning off the developing bias, and the processing for stopping the transfer belt 21, the photoconductive drum 25, and the magnet roller 38 (FIG. 2).

The controller 18 turns of the charging bias. If an absolute value of the potential of the charging bias is smaller than an absolute value of the potential of the developing bias because of process characteristics, the controller 18 causes the toner to adhere to the photoconductive drum 25 (FIG. 7B).

After a fixed time elapses from the OFF timing for the charging bias, the controller 18 turns off the developing bias, whereby the toner bands 60, 61, 62, and 63 are formed (FIG. 9A, etc.).

The controller 18 transfers the toner bands 60, 61, 62, and 63 formed for each of the colors onto the belt 21. The toner deposit sensor 20 reads the transferred toner bands 60, 61, 62, and 63 (FIG. 8).

The controller 18 estimates a state in the developing device 27 from a result of the reading and determines the amount of the supply of toner.

The MFP 10 can detect density using the toner bands at the end of printing. The MFP 10 can form test patterns during process time of the normal printing process.

The MFP 10 can detect the amount of the supply of toner without increasing a processing time. The MFP 10 can realize control of toner supply without using a toner sensor.

### Second Embodiment

In the first embodiment, the MFP 10 executes the analog development process during the reversal development process at the end of printing. An image forming apparatus according to a second embodiment executes analog development during a reversal development process at the start of printing.

The image forming apparatus according to the second embodiment is also the MFP 10. In a method of calculating the amount of the supply of toner according to the second embodiment, as in the first embodiment, formation of a toner band, reading of the density of the toner band, and calculation of the amount of the supply of toner using the density are performed.

Otherwise, the configuration of the MFP 10 is substantially the same as the example in the first embodiment.

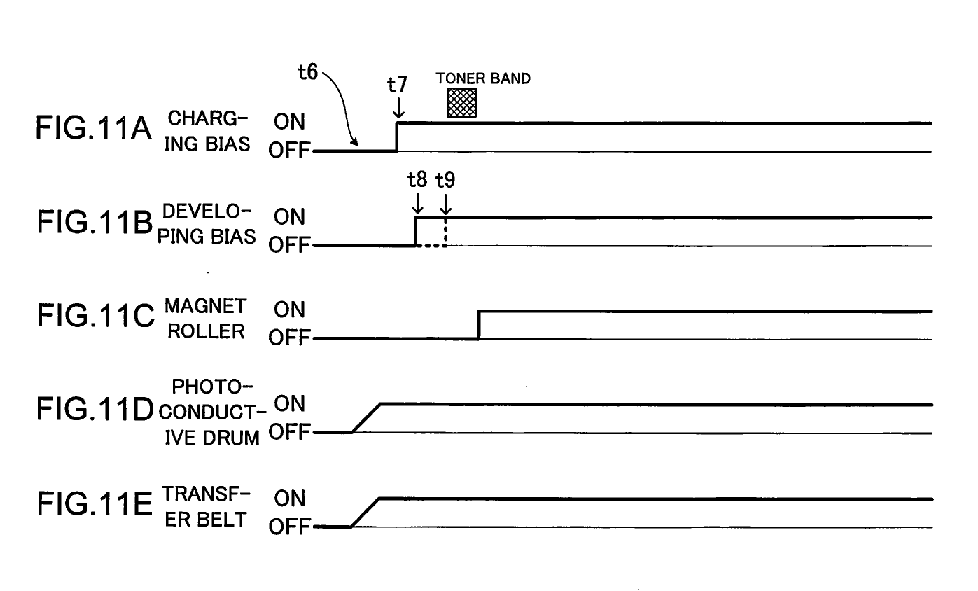

FIGS. 11A to 11E are timing charts for explaining processing for starting a series of printing processes by the image forming apparatus according to the second embodiment.

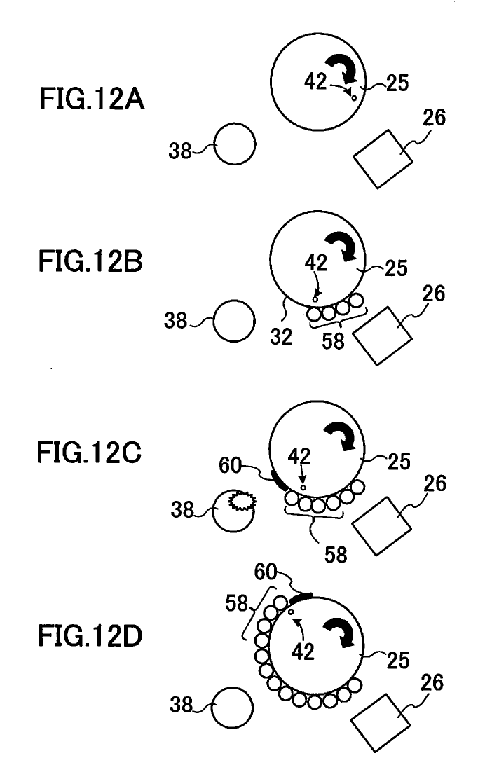

FIGS. 12A to 12D are diagrams of charging states on the photoconductive drum 25 used in the image forming apparatus according to the second embodiment. The reference numerals and signs already described above denote the same components.

Development for yellow is explained below. At time t6 shown in FIG. 11A, as shown in FIG. 12A, the photoconductive drum 25 is not charged at all in the drum circumferential length direction.

First, as shown in FIG. 11D, the controller 18 starts to rotate the photoconductive drum 25. As shown in FIG. 11E, the controller 18 starts to cause the belt 21 to travel.

Thereafter, the mark 42 is opposed to the charging device 26 according to the rotation of the photoconductive drum 25. At time t7 shown in FIG. 11A, the controller 18 turns on a charging bias.

The photoconductive drum 25 further rotates. As shown in FIG. 12B, the photoconductive member 32 starts to be partially charged in the drum circumferential length direction.

Before an uncharged portion reaches the development position, a time t8 shown in FIG. 11B, the controller 18 turns on a developing bias.

As shown in FIGS. 11C and 12C, the controller 18 starts to rotate the magnet roller 38. According to the rotation of the photoconductive drum 25, the uncharged portion is opposed to the magnet roller 38. As a result, the toner band 60 starts to be formed by an analog development process.

The photoconductive drum 25 further rotates. At timing when a toner band having band width of about 1 cm is formed, the head of the portion 58 charged on the photoconductive member 32 reaches the magnet roller 38.

An absolute value of the potential of the charged photoconductive member 32 is larger than an absolute value of the potential of the developing bias. The toner is no longer attracted because of the relation of a potential difference shown in FIG. 7A. The band width of the toner band 60 does not further increase.

Further, the photoconductive drum 25 rotates as shown in FIG. 12D. Thereafter, the controller 18 starts exposure for printing on a sheet. In other words, the controller 18 completes the analog development process before the start of exposure in a printing process.

Time t9 shown in FIG. 11B represents an example of an image forming apparatus according to a comparative example. In the image forming apparatus according to the comparative example, after a portion having charges in a charged portion reaches a developing device, a controller turns off the developing bias.

Time t9 is timing when the portion having charges reaches the development position. A method according to the comparative example does not cause a relation shown in FIG. 12C in the image forming apparatus.

On the other hand, the controller 18 of the MFP 10 sets timing for turning off the development bias earlier than time t9 when the developing bias is turned off in the comparative example.

In other words, the controller 18 sets ON timing of the developing bias earlier to generate the toner band 60. Timing adjustment for the magenta toner band 61, the cyan toner band 62, and the black toner band 63 is substantially the same as the example of the yellow toner band 60.

The toner deposit sensor 20 reads resultant transferred toner bands 60, 61, 62, and 63. The controller determines amounts of supply of toners for the respective colors.

The MFP 10 is able to change the length of a toner band by adjusting time from the turn-off of the charging bias until the turn-off of the developing bias. If an amount of toner consumption by the formation of the toner bands 60, 61, 62, and 63 is suppressed, the controller 18 may set timing for turning off the developing bias earlier.

The controller 18 may adjust the band length of the toner band in color printing and in monochrome printing.

The MFP 10 can detect density using the toner band at the start of printing. In this way, the MFP 10 can form a test pattern for detecting a toner deposit during processing time of the normal printing process.

The MFP 10 can detect an amount of supply toner without increasing the processing time. The MFP 10 can realize toner supply control without using a toner sensor. Modifications

A period when the analog development process is started can be changed.

For example, during execution of a startup mode of the MFP 10, the controller 18 may instruct bias application before or after the uncharged portion on the photoconductive member 32 reaches the opposed position opposed to the magnet roller 38.

During execution of calibration, the controller 18 may instruct the bias application before or after the uncharged portion on the photoconductive member 32 reaches the opposed position opposed to the magnet roller 38. The calibration indicates automatic calibration for correction of the density of printing on a sheet or an image read from an original document.

During execution of driving of the drum motor 54, the controller 18 may instruct the bias application before or after the uncharged portion on the photoconductive member 32 reaches the opposed position opposed to the magnet roller 38.

The controller 18 may instruct the bias application when a jam is detected by a jam sensor 65.

The controller 18 may instruct the bias application when the photoconductive member 32 is cleaned by the cleaner 29.

The controller 18 may instruct the bias application when a warming-up mode of the MFP 10 is executed.

### Others

In the image forming apparatus according to the embodiments, a plus toner may be used. The polarity of the charging bias and the polarity of the developing bias are set to plus.

The toner deposit sensor 20 may use an infrared ray. The MFP 10 includes plural toner deposit sensors 20. The number of sensors can be changed.

Superiority of the image forming apparatus according to the embodiments over a product obtained by simply changing the configuration shown in FIGS. 2 to 4 and implementing the configuration is not spoiled at all.

In the embodiments, the image forming apparatus is the MFP 10. However, the image forming apparatus may be a printer or a copying machine. The calculation method according to the embodiments can be applied to an image forming apparatus in general mounted with a sensor configured to measure a toner deposit.

While certain embodiments have been described, these embodiments have been presented by way of example only, and are not intended to limit the scope of the inventions. Indeed, the novel methods and systems described herein may be embodied in a variety of other forms; furthermore various omissions and substitutions and changes in the form of methods and systems described herein may be made without departing from the spirit of the inventions. The accompanying claims and their equivalents are intended to cover such forms or modifications as would fall within the scope and spirits of the inventions.

What is claimed is:

1. An image forming apparatus comprising:
a drum driven to rotate around an axis in a drum rotating direction;
a photoconductive member on an outer circumferential surface of the drum;
a charging device configured to charge the photoconductive member;
a developing device configured to supply a toner to the photoconductive member further downstream in the drum rotating direction than the charging device;
a toner supplying section configured to supply the toner to the developing device;
a transfer member onto which a toner image on the photoconductive member is transferred further downstream in the drum rotating direction than the developing device;
a sensor configured to measure density of a toner band adhering on the transfer member;
a process control section configured to control operation of the sensor, separately control on and off of a developing bias to the developing device and on and off of a charging bias to the charging device, and control execution of a printing process on a sheet;
a timing adjusting section configured to instruct the process control section to turn on the developing bias at timing when a portion not substantially charged on the photoconductive member of the drum rotated by the control by the process control section is opposed to the developing device; and
a calculating section configured to calculate, according to a result obtained by the sensor measuring the density of the toner band formed by the developing bias enabled by the timing adjusting section, an amount of supply of toner from the toner supplying section into the developing device.

2. The apparatus of claim 1, wherein the process control section executes a reversal development process for causing a latent image, from which charges on the photoconductive member are removed by exposure, to attract a toner having polarity same as potential polarity of the latent image and executes, during the reversal development process, an analog development process for causing an unexposed portion not exposed on the photoconductive member to attract the toner.

3. The apparatus of claim 2, wherein the timing adjusting section turns off the charging bias in an ON state and, after the portion not substantially charged reaches from a first opposed position opposed to the charging device to a second opposed position opposed to the developing device and passes the second opposed position, instructs the process control section to turn on the developing bias.

4. The apparatus of claim 2, wherein the timing adjusting section turns on the charging bias in an OFF state and, before the portion not substantially charged reaches from a first opposed position opposed to the charging device to a second opposed position opposed to the developing device prior to the turn-on of the charging bias, instructs the process control section to turn on the developing bias.

5. The apparatus of claim 2, wherein the timing adjusting section turns off the developing bias at timing when, of band length and band width of the toner band, the band width has width sufficient for the detection of the density by the sensor.

6. The apparatus of claim 2, wherein the timing adjusting section instructs, while the process control section is executing a startup mode of the image forming apparatus, the process control section to turn on the developing bias before or after the portion not substantially charged reaches a second opposed position opposed to the developing device.

7. The apparatus of claim 2, wherein the timing adjusting section instructs, while the process control section is executing calibration for correction of printing density or an image, the process control section to turn on the developing bias before or after the portion not substantially charged reaches a second opposed position opposed to the developing device.

8. The apparatus of claim 2, wherein the timing adjusting section instructs, while the process control section is executing driving of a drum motor configured to rotate the drum, the process control section to turn on the developing bias before or after the portion not substantially charged reaches a second opposed position oppose to the developing device.

9. The apparatus of claim 8, wherein timing when the timing adjusting section instructs the process control section to turn on the developing bias is timing when the process control section detects a jam using a jam sensor.

10. The apparatus of claim 8, wherein timing when the timing adjusting section instructs the process control section to turn on the developing bias is timing when the process control section cleans the photoconductive member using a cleaner.

11. The apparatus of claim 8, wherein timing when the timing adjusting section instructs the process control section to turn on the developing bias is timing when the process control section executes a warming-up mode of the image forming apparatus.

12. The apparatus of claim 2, further comprising a table configured to store a correspondence relation between intensity information of reflected light and information concerning an amount of toner to be supplied, wherein
the calculating section determines the amount of the supply of toner according to a sensor output having a level corresponding to density of an image of the toner band from the sensor and the correspondence relation.

13. The apparatus of claim 2, wherein the sensor includes a light emitting element configured to emit a light beam and a light receiving element configured to optically read a reflected light beam reflected on a toner transfer surface of the transfer member.

14. A method of calculating an amount of supply of toner, the method comprising:
starting a printing process including a reversal development process for causing a latent image, from which charges on a photoconductive member are removed by exposure, to attract a toner having polarity same as potential polarity of the latent image;
generating, during the reversal development process, a toner band using an analog development process for causing an unexposed portion not exposed on the photoconductive member to attract the toner;
transferring the toner band from the photoconductive member onto a belt;
detecting density of the toner band on the belt; and
calculating the amount of the supply of toner to a developing device according to the density.

15. The method of claim 14, wherein the analog development process is completed before the printing process ends.

16. The method of claim 14, wherein the analog development process is completed before the exposure in the printing process is started.

17. The method of claim 14, wherein the generating the toner band using the analog development process includes instructing turn-on of the developing bias at timing when a portion not substantially charged on the photoconductive member is opposed to the developing device.

18. The method of claim 14, wherein the generating the toner band using the analog development process includes:
turning off a charging bias in an ON state;
causing a portion not substantially charged on the photoconductive member to reach from a first opposed position opposed to a charging device to a second opposed position opposed to the developing device; and
instructing application of the developing bias after causing the portion to pass the second opposed position.

19. The method of claim 14, wherein the generating the toner band using the analog development process includes:
turning on a charging bias in an OFF state; and
instructing application of the developing bias before causing a portion not substantially charged on the photoconductive member to reach from a first opposed position opposed to a charging device to a second opposed position opposed to the developing device.

20. The method of claim 14, wherein the calculating the amount of the supply of toner according to the density includes:
providing in advance, prior to the calculation, a table that stores a correspondence relation between intensity information of reflected light and information concerning an amount of toner to be supplied; and
determining the amount of the supply of toner to be supplied according to a sensor output having a level corresponding to density of an image of the toner band from an optical sensor and the correspondence relation stored in the table.
